(19) United States
(12) Patent Application Publication
(10) Pub. No.: US 2026/0138439 A1
(43) Pub. Date: May 21, 2026

(54) VEHICLE TRIM PANEL WITH AIR-GUIDING POCKET

(71) Applicant: FORD GLOBAL TECHNOLOGIES, LLC, Dearborn, MI (US)

(72) Inventors: Graham Lloyd Feltham, Canton, MI (US); Zachary Kochanek, Belleville, MI (US); Michael Kelley, Allen Park, MI (US)

(21) Appl. No.: 18/952,015

(22) Filed: Nov. 19, 2024

(51) Int. Cl. B60K 11/08; B60R 13/06

(52) U.S. Cl. CPC B60K 11/08; B60R 13/06

(57) ABSTRACT

A device may include a first heat exchanger of a vehicle. A device may include a second heat exchanger of the vehicle, the second heat exchanger aft the first heat exchanger, the second heat exchanger extending vertically above the first heat exchanger. A device may include a trim panel having a pocket that opens vertically upward, the pocket having a floor and at least one sidewall that extends vertically upward from the floor, the at least one sidewall configured to guide a flow of air to at least the second heat exchanger.

### TECHNICAL FIELD

This disclosure relates generally to a vehicle trim panel having a pocket that can guide air to a heat exchanger, such as a radiator.

### BACKGROUND

Vehicles can include trim panels in various areas. Some vehicles include trim panels within or near vehicle compartments, such as an engine compartment or frunk.

### SUMMARY

In some aspects, the techniques described herein relate to a vehicle assembly, including: a first heat exchanger of a vehicle; a second heat exchanger of the vehicle, the second heat exchanger aft the first heat exchanger, the second heat exchanger extending vertically above the first heat exchanger; and a trim panel having a pocket that opens vertically upward, the pocket having a floor and at least one sidewall that extends vertically upward from the floor, the at least one sidewall configured to guide a flow of air to at least the second heat exchanger.

In some aspects, the techniques described herein relate to a vehicle assembly, wherein the first heat exchanger is positioned directly beneath the floor of the pocket.

In some aspects, the techniques described herein relate to a vehicle assembly, wherein the first heat exchanger is spaced a distance from the floor to allow a portion of the flow of air to bypass the first heat exchanger and to flow between the floor and the first heat exchanger.

In some aspects, the techniques described herein relate to a vehicle assembly, wherein the trim panel includes a first baffle and a second baffle, the first baffle and the second baffle each extend vertically downward from the floor to a position vertically beneath an uppermost portion the first heat exchanger relative to the floor.

In some aspects, the techniques described herein relate to a vehicle assembly, wherein the first baffle is forward the first heat exchanger and diverts the flow of air toward the first heat exchanger, the second baffle is aft the first heat exchanger and diverts air aft the first heat exchanger toward the second heat exchanger.

In some aspects, the techniques described herein relate to a vehicle assembly, further including a seal component between the first heat exchanger and the floor to block the bypass air from flowing between the first heat exchanger and the floor.

In some aspects, the techniques described herein relate to a vehicle assembly, wherein the first heat exchanger contacts the floor.

In some aspects, the techniques described herein relate to a vehicle assembly, wherein the first heat exchanger is a condenser and the second heat exchanger is a transmission cooler.

In some aspects, the techniques described herein relate to a vehicle assembly, wherein the second heat exchanger extends vertically above the floor of the pocket.

In some aspects, the techniques described herein relate to a vehicle assembly, wherein the at least one sidewall of the pocket includes a front sidewall forward the first heat exchanger and a rear sidewall aft the first heat exchanger, the rear sidewall extending from the floor at an angle over the second heat exchanger.

In some aspects, the techniques described herein relate to a vehicle assembly, further including one or more dividers of the pocket that extend between the front sidewall and the rear sidewall to provide one or more sections within the pocket, wherein each of the sections is configured to hold one or more items.

In some aspects, the techniques described herein relate to a vehicle assembly, further including a third heat exchanger aft the second heat exchanger, the third heat exchanger extending vertically above the second heat exchanger.

In some aspects, the techniques described herein relate to a vehicle assembly, wherein the at least one sidewall of the pocket includes a front sidewall forward the first heat exchanger and a rear sidewall aft the first heat exchanger.

In some aspects, the techniques described herein relate to a vehicle assembly, wherein the rear sidewall extends from the floor at an angle over the second heat exchanger and the third heat exchanger, the rear sidewall configured to guide the flow of air downward through the second heat exchanger and the third heat exchanger.

In some aspects, the techniques described herein relate to a vehicle assembly, wherein the third heat exchanger is a radiator.

In some aspects, the techniques described herein relate to a vehicle assembly, further including a cover of the trim panel, the cover configured to pivot back and forth between a closed position and an open position, the cover covering more of the pocket when the cover is in the closed position than when the cover is in the open position.

In some aspects, the techniques described herein relate to a vehicle flow guiding method, including: receiving a flow of air within a vehicle; and guiding the flow of air rearward from a first heat exchanger to a second heat exchanger with at least a sidewall of a pocket, the pocket provided in a trim panel, the pocket opening upward.

In some aspects, the techniques described herein relate to a vehicle flow guiding method, wherein the guiding includes blocking the flow of air from flowing between the first heat exchanger and the pocket.

In some aspects, the techniques described herein relate to a vehicle flow guiding, wherein the sidewall of the pocket is a front sidewall, and wherein the guiding includes guiding the flow of air to a third heat exchanger with a rear sidewall of the pocket, the third heat exchanger aft of the second heat exchanger, the third heat exchanger extending vertically above the second heat exchanger.

In some aspects, the techniques described herein relate to a vehicle flow guiding method, wherein the first heat exchanger is a condenser, the second heat exchanger is a transmission cooler, and the third heat exchanger is a radiator.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1 illustrates a perspective view of a trim panel near a compartment of a vehicle according to an exemplary aspect of the present disclosure.

FIG. 2 illustrates a top view of the trim panel and the compartment of FIG. 1 with a cover of the trim panel in a closed position.

FIG. 3 illustrates a perspective view of the trim panel of FIGS. 1 and 2.

FIG. 4 illustrates a section view taken at line 4-4 in FIG. 1.

FIG. 5 illustrates a section view at the position of FIG. 4 taken through a trim panel according to another exemplary embodiment of the present disclosure.

FIG. 6 illustrates a section view at the position of FIG. 4 taken through a trim panel according to yet another exemplary embodiment of the present disclosure.

### DETAILED DESCRIPTION

This disclosure details exemplary trim panels for vehicles. The trim panels have a pocket that opens vertically upward. The pocket can be used to store items (e.g., tools, equipment, etc.). The pocket can also guide a flow of air to at least one heat exchanger of the vehicle. These and other features are discussed in greater detail in the following paragraphs of this detailed description.

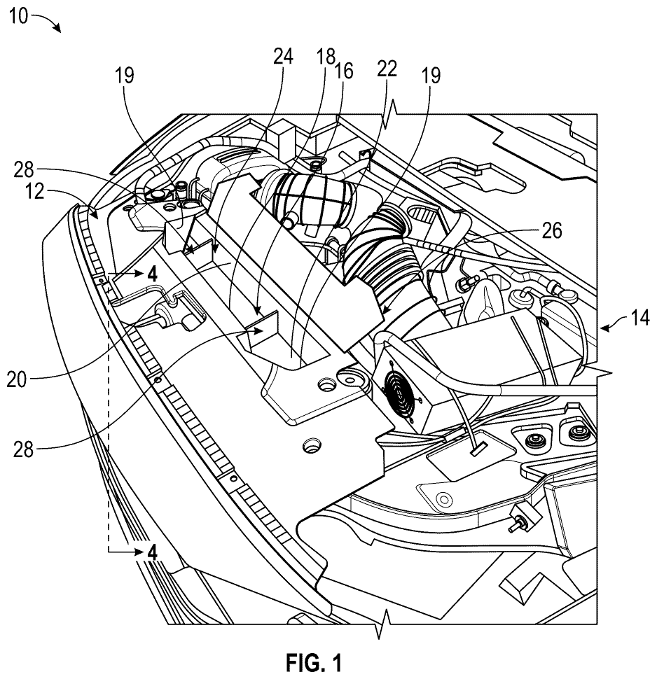

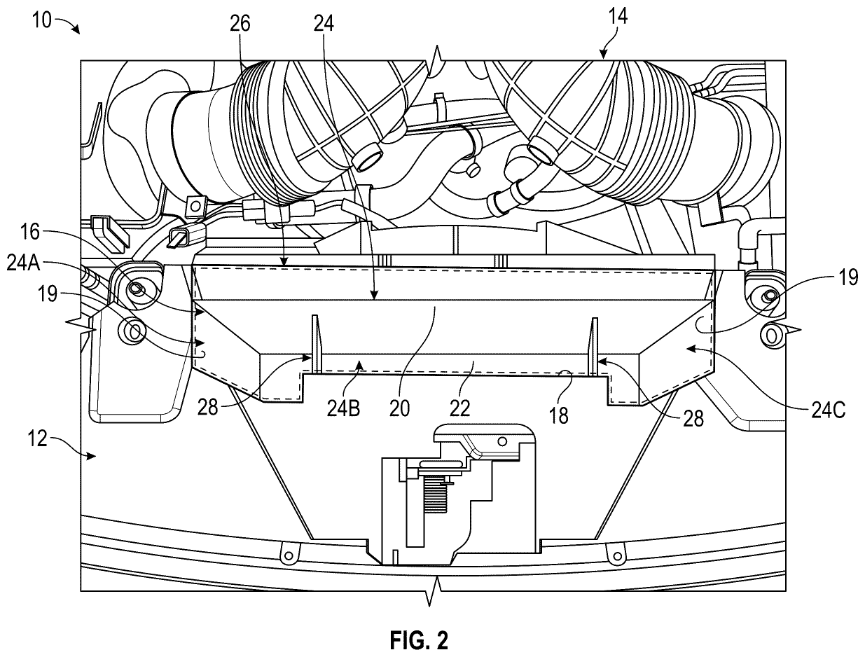

With reference to FIGS. 1 and 2, a vehicle 10 includes a trim panel 12 near a compartment 14 of the vehicle 10. In the exemplary embodiment, the vehicle 10 is a car. However, the vehicle 10 could alternatively be a pickup truck, van, sports utility vehicle (SUV), or any other vehicle configuration.

The example trim panel 12 is positioned in front of the compartment 14 (e.g., engine compartment or frunk). In this embodiment, the trim panel 12 is a cover that conceals various areas and components, such as latch mechanisms that secure a vehicle closure module (e.g., a hood) in a closed position and allow it to pivot from the closed position to an open position to access the compartment 14.

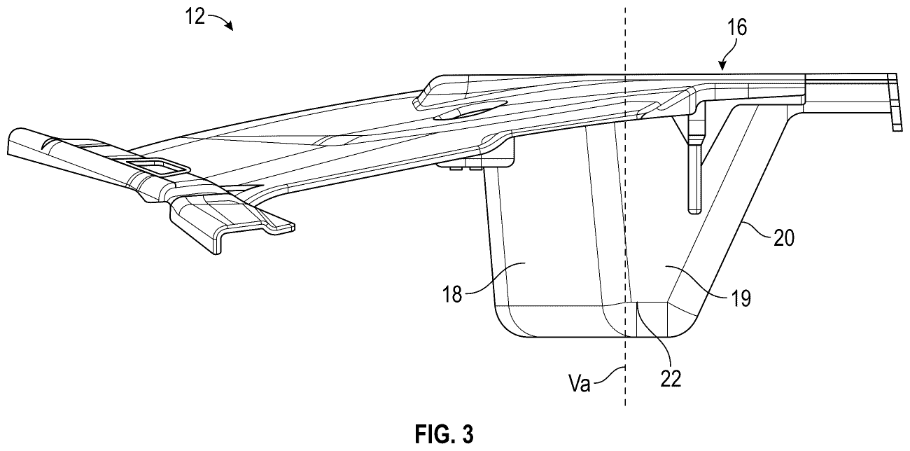

Referring now to FIG. 3, with continuing reference to FIGS. 1 and 2, the trim panel 12 includes a pocket 16. The pocket 16 opens vertically upward in this example. The pocket 16 is provided by a front sidewall 18, opposed outboard sidewalls 19, and a rear sidewall 20 extending vertically upward from a floor 22.

The floor 22 establishes a lower boundary of the pocket 16. The front sidewall 18 extends generally upward from the floor 22 and establishes a front boundary of the pocket 16. The outboard sidewalls 19 extend generally upward from the floor 22 and establish left and right boundaries of the pocket 16. The rear sidewall 20 extends rearward and upward from the floor 22 and establishes a rear boundary of the pocket 16.

In this example, the front sidewall 18 is more vertically aligned than the rear sidewall 20. In particular, the front sidewall 18 extends upward substantially perpendicular to the floor 22 and tilted forward at an angle no more than say five degrees from a vertical axis Va. The rear sidewall 20 extends upward and rearward from the floor 22 at an angle of approximately 30 degrees from the vertical axis Va. The angle of the rear sidewall 20 gives the pocket 16 a variable depth on the rear side of the pocket 16. The depth gradually decreases moving rearward. A horizontal distance between the front sidewall 18 and the second sidewall 20 increases moving upward away from the floor 22. That is, the pocket 16 widens moving upward from the floor 22 (i.e., the pocket 16 has a variable width).

The pocket 16 provides a storage space 24 that a user can utilize to store one or more items (e.g., tools, equipment, etc.). The front sidewall 18, the outboard sidewalls 19, the rear sidewall 20, and the floor 22 provide boundaries to support items within the pocket 16.

In the example embodiment, the trim panel 12 includes a cover 26 configured to pivot back and forth between an open position (FIG. 1) and a closed position (FIG. 2). When in the open position, the cover 26 is lifted away from the pocket 16 to allow users to place items in the pocket 16 or retrieve them as needed. When in the closed position, the cover 26 encloses or otherwise covers the pocket 16. The cover 26 could be attached to the rear sidewall 20 with a hinge to allow the cover 26 to move between the open and closed positions. The cover 26 could be removable in other examples.

In the exemplary embodiment, one or more dividers 28 extend from the floor 22 between the front sidewall 18 and the rear sidewall 20 to divide the storage space 24 into a first section 24A, a second section 24B, and a third section 24C (FIG. 2). Each of the sections 24A-24C is configured to hold one or more items. In a further embodiment, a cup holder can be molded into one of the sections 24A-24C.

The floor 22 can include drain holes to allow fluids (e.g., water, etc.) to drain out of the pocket 16.

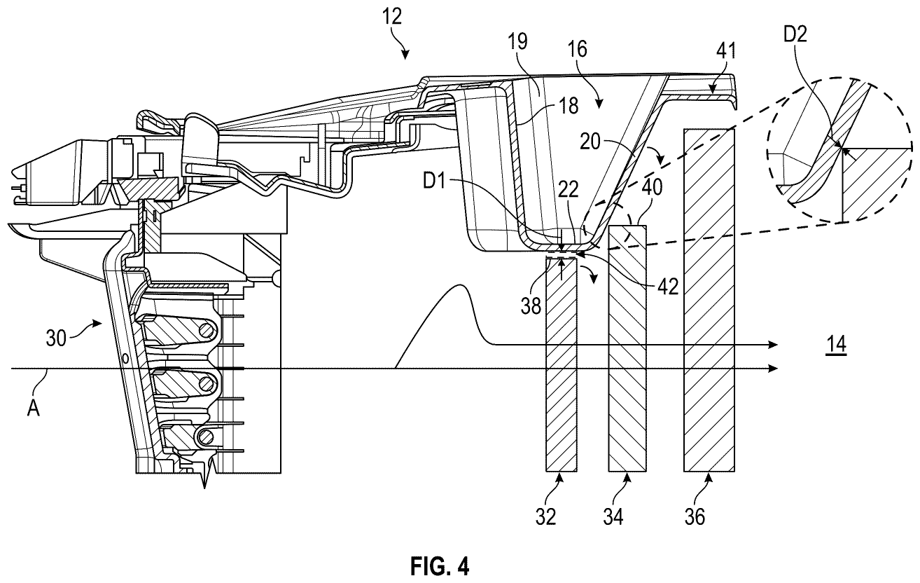

Referring now to FIG. 4, the vehicle includes a front grille 30, a first heat exchanger 32, a second heat exchanger 34, and a third heat exchanger 36. The first heat exchanger 32 is a condenser that functions as part of the vehicle air conditioning (AC) system to cool the passenger compartment of the vehicle 10. In this example, the vehicle 10 includes a turbocharged or supercharged engine and relies on the second heat exchanger 34 as a transmission cooler that uses air to cool transmission fluid. The second heat exchanger 34 is aft the first heat exchanger 32 and extends vertically above the first heat exchanger 32. The third heat exchanger 36 is a radiator that uses the air to cool engine coolant (e.g., antifreeze) before returning it to the engine. The third heat exchanger 36 is aft the second heat exchanger 34 and extends vertically above the second heat exchanger 34.

In this example, the first heat exchanger 32 is positioned directly beneath the floor 22 of the pocket 16. An uppermost portion 38 of the first heat exchanger 32 and an underside of the floor 22 are spaced apart by a distance D1.

The second heat exchanger 34 is positioned directly beneath the rear sidewall 20 of the pocket 16. An uppermost portion 40 of the second heat exchanger 34 and an underside of the rear sidewall 20 are spaced apart by a distance D2. In the exemplary embodiment, the distance D2 is less than the distance D1.

The third heat exchanger 36 is positioned directly beneath an underside of a flange 41 that extends laterally from an upper end portion of the rear sidewall 20. In an embodiment, the second heat exchanger 34 and the third heat exchanger 36 extend vertically above the floor 22.

As the vehicle 10 is driven forward, a flow of air A passes through the front grille 30. The air A from the front grille 30 flows rearward toward the first heat exchanger 32, the second heat exchanger 34, and the third heat exchanger 36. The trim panel 12—particularly the pocket 16 of the trim panel 12—is configured to guide air in the compartment 14 to the first heat exchanger 32, the second heat exchanger 34, and the third heat exchanger 36.

In this example, the front sidewall 18 of the pocket 16 is forward the first heat exchanger 32. Air A that enters the compartment 14 through the front grille 30 flows toward the first heat exchanger 32 and some of the air can flow upward toward the front sidewall 18. The front sidewall 18 redirects the air A downward toward the first heat exchanger 32. Some of the air A may bypass the first heat exchanger 32 and flow between the floor 22 and the first heat exchanger 32. That is, the first heat exchanger 32 being spaced apart from the floor 22 by the distance D1 allows bypass air to flow around or otherwise over the uppermost portion 38 of the first heat exchanger 32 without passing through the first heat exchanger 32.

In an embodiment, a seal component 42 (indicated in dashed lines for illustrative purposes is arranged between the floor 22 and the first heat exchanger 32 to block bypass air from flowing therebetween. The seal component 42 blocks air A from moving between the floor 22 and the first heat exchanger 32 and redirects the air through the first heat exchanger 32.

The rear sidewall 20 of the pocket 16 is aft the first heat exchanger 32 and extends at an angle over the second heat exchanger 34 to horizontally overlap the second heat exchanger 34. Air A aft the first heat exchanger 32 can be guided downward by the angled rear sidewall 20 to ensure that most of the air passes through the second heat exchanger 34. In one embodiment, the distance D2 between the rear sidewall 20 and the uppermost portion 40 can be made narrow to reduce a potential for air A bypassing the second heat exchanger 34. As shown, the rear sidewall 20, in this example, also extends at least partially over the third heat exchanger 36 to guide air A downward toward the third heat exchanger 36.

The angled slope of the rear sidewall 20 reduces the space available for air A to move upward and/or expand outward around the second heat exchanger 34, the third heat exchanger 36, or both. By guiding the air A downward toward the second and third heat exchangers 34, 36, the rear sidewall 20 can reduce the possibility of forming large pockets of circulating air that could lead to turbulence.

In this disclosure, like reference numerals designate like elements where appropriate and reference numerals with the addition of one-hundred or multiples thereof designate modified elements that are understood to incorporate the same features and benefits of the corresponding elements.

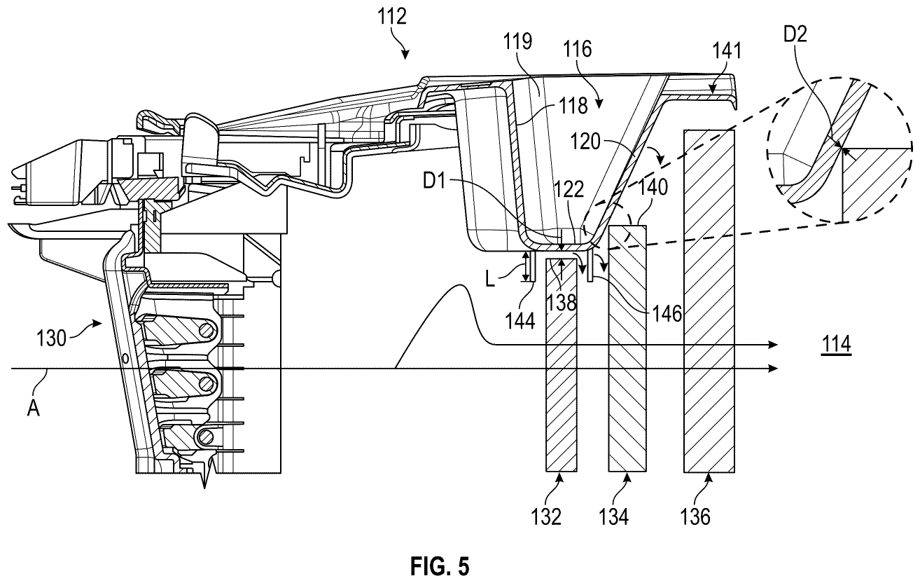

FIG. 5 illustrates another exemplary trim panel 112. The trim panel 112 is supported within a compartment 114 of a vehicle 110. The trim panel 112 includes a pocket 116 that opens vertically upwards. The pocket 116 is provided by a front sidewall 118, opposed outboard sidewalls 119, and a rear sidewall 120 extending vertically upward from a floor 122. A flow of air A can pass through a front grille 130 of the vehicle 110 to cool fluid within a plurality of heat exchangers (e.g., a first heat exchanger 132, a second heat exchanger 134, and a third heat exchanger 136) arranged in the compartment 114. The first heat exchanger 132 is spaced from the floor 122 to allow a portion of the flow of air to bypass the first heat exchanger 132 and to flow between the floor 122 and the first heat exchanger 132.

In this embodiment, the trim panel 112 includes a first baffle 144 and a second baffle 146 that each extend vertically downward from the floor 122 to a position vertically beneath an uppermost portion 138 of the first heat exchanger 132. In an embodiment, each of the first and second baffles 144, 146 has a length L that is greater than the distance D1 between the floor 122 and the first heat exchanger 132. In an embodiment, the first baffle 144 serves as a vertical extension of the front sidewall 118 and the second baffle 146 serves as a vertical extension of the rear sidewall 120.

The first baffle 144 is forward the first heat exchanger 132 and diverts air A downward toward the first heat exchanger 132.

The second baffle 146 is aft the first heat exchanger 132. The second baffle 146 can divert air that passes between the floor 122 and the first heat exchanger 132 downward toward the second heat exchanger 134. Air that is not redirected by the second baffle 146 is guided by the rear sidewall 120 through the second heat exchanger 134.

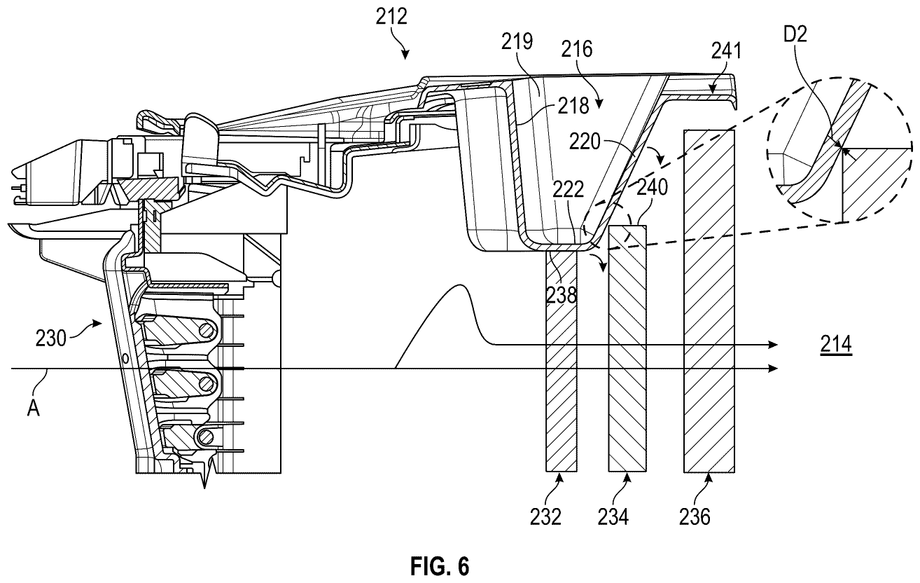

FIG. 6 illustrates another exemplary trim panel 212. The trim panel 212 is supported within a compartment 214 of a vehicle 210. The trim panel 212 includes a pocket 216 that opens vertically upwards. The pocket 216 is provided by a front sidewall 218, opposed outboard sidewalls 219, and a rear sidewall 220 extending vertically upward from a floor 222.

A flow of air A can pass through a front grille 230 of the vehicle 210 to cool fluid within a plurality of heat exchangers (e.g., a first heat exchanger 232, a second heat exchanger 234, and a third heat exchanger 236) arranged in the compartment 214. In this embodiment, the pocket 216 is extended such that the floor 222 directly contacts an uppermost portion 238 of the first heat exchanger 232. This arrangement blocks bypass air from flowing between the floor 222 and the first heat exchanger 232. The air that is blocked can be redirected downward through the first heat exchanger 232 before it passes through the second heat exchanger 134 and the third heat exchanger 136.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a first heat exchanger of a vehicle;
a second heat exchanger of the vehicle, the second heat exchanger aft the first heat exchanger, the second heat exchanger extending vertically above the first heat exchanger; and
a trim panel having a pocket that opens vertically upward, the pocket having a floor and at least one sidewall that extends vertically upward from the floor, the at least one sidewall configured to guide a flow of air to at least the second heat exchanger.

2. The vehicle assembly as recited in claim 1, wherein the first heat exchanger is positioned directly beneath the floor of the pocket.

3. The vehicle assembly as recited in claim 2, wherein the first heat exchanger is spaced a distance from the floor to allow a portion of the flow of air to bypass the first heat exchanger and to flow between the floor and the first heat exchanger.

4. The vehicle assembly as recited in claim 3, wherein the trim panel includes a first baffle and a second baffle, the first baffle and the second baffle each extend vertically downward from the floor to a position vertically beneath an uppermost portion the first heat exchanger relative to the floor.

5. The vehicle assembly as recited in claim 4, wherein the first baffle is forward the first heat exchanger and diverts the flow of air toward the first heat exchanger, the second baffle is aft the first heat exchanger and diverts air aft the first heat exchanger toward the second heat exchanger.

6. The vehicle assembly as recited in claim 3, further comprising a seal component between the first heat exchanger and the floor to block the bypass air from flowing between the first heat exchanger and the floor.

7. The vehicle assembly as recited in claim 2, wherein the first heat exchanger contacts the floor.

8. The vehicle assembly as recited in claim 1, wherein the first heat exchanger is a condenser and the second heat exchanger is a transmission cooler.

9. The vehicle assembly as recited in claim 1, wherein the second heat exchanger extends vertically above the floor of the pocket.

10. The vehicle assembly as recited in claim 1, wherein the at least one sidewall of the pocket comprises a front sidewall forward the first heat exchanger and a rear sidewall aft the first heat exchanger, the rear sidewall extending from the floor at an angle over the second heat exchanger.

11. The vehicle assembly as recited in claim 10, further comprising one or more dividers of the pocket that extend between the front sidewall and the rear sidewall to provide one or more sections within the pocket, wherein each of the sections is configured to hold one or more items.

12. The vehicle assembly as recited in claim 1, further comprising a third heat exchanger aft the second heat exchanger, the third heat exchanger extending vertically above the second heat exchanger.

13. The vehicle assembly as recited in claim 12, wherein the at least one sidewall of the pocket comprises a front sidewall forward the first heat exchanger and a rear sidewall aft the first heat exchanger.

14. The vehicle assembly as recited in claim 13, wherein the rear sidewall extends from the floor at an angle over the second heat exchanger and the third heat exchanger, the rear sidewall configured to guide the flow of air downward through the second heat exchanger and the third heat exchanger.

15. The vehicle assembly as recited in claim 12, wherein the third heat exchanger is a radiator.

16. The vehicle assembly as recited in claim 1, further comprising a cover of the trim panel, the cover configured to pivot back and forth between a closed position and an open position, the cover covering more of the pocket when the cover is in the closed position than when the cover is in the open position.

17. A vehicle flow guiding method, comprising:
receiving a flow of air within a vehicle; and
guiding the flow of air rearward from a first heat exchanger to a second heat exchanger with at least a sidewall of a pocket, the pocket provided in a trim panel, the pocket opening upward.

18. The vehicle flow guiding method as recited in claim 17, wherein the guiding includes blocking the flow of air from flowing between the first heat exchanger and the pocket.

19. The vehicle flow guiding as recited in claim 17, wherein the sidewall of the pocket is a front sidewall, and wherein the guiding includes guiding the flow of air to a third heat exchanger with a rear sidewall of the pocket, the third heat exchanger aft of the second heat exchanger, the third heat exchanger extending vertically above the second heat exchanger.

20. The vehicle flow guiding method as recited in claim 19, wherein the first heat exchanger is a condenser, the second heat exchanger is a transmission cooler, and the third heat exchanger is a radiator.
